(19) United States
(12) Patent Application Publication
(10) Pub. No.: US 2008/0288914 A1
(43) Pub. Date: Nov. 20, 2008

(54) Method and software for collaboration

(75) Inventor: Eric Schmitter, Chula Vista, CA (US)

Correspondence Address: MAYER & WILLIAMS PC, 251 NORTH AVENUE WEST, 2ND FLOOR, WESTFIELD, NJ, 07090, US

(73) Assignee: Blueshift Collaborative Research, Inc., Chula Vista, CA (US)

(21) Appl. No.: 11/903,603

(22) Filed: Sep. 24, 2007

Related U.S. Application Data
(60) Provisional application No. 60/930,836, filed on May 18, 2007.

(51) Int. Cl. G06F 9/44

(52) U.S. Cl. 717/101

(57) ABSTRACT

A method and software to allow direct input for projects, either by all users of a network, a defined group of users, or various populations in between. The projects may be, e.g., collaborative design efforts, marketing efforts for a given product, and so on. The system provides a software and service platform that may be implemented either as an Internet-based social collaboration service or a stand-alone software platform. The system provides a social Internet community framework that allows users to create short-cycle projects or contests that present a request, scenario or problem and asks the user community to collaborate on ideas and solutions that solve or fit the request. Anyone in the user community, or outside the user community, can start new projects and participate in existing projects by adding and collaborating on ideas. Through a selection process, e.g., community voting, a prevailing or winning idea is selected and all contributors to the prevailing idea are rewarded.

### CROSS-REFERENCE TO RELATED APPLICATIONS

This application claims the benefit of U.S. Provisional Patent Application Ser. No. 60/930,836, filed May 18, 2007, entitled “Method and Software for Collaboration”, which is incorporated herein by reference in its entirety.

### BACKGROUND

Companies in every industry are interested in new methods of innovation, design and research. Other companies, as advertisers, are interested in finding ways to expand their or their clients' brand, products and/or services within large online communities and social networking websites.

Prior efforts have relied on individual marketing efforts, either via in-house marketing teams or via outsourced marketing firms. While such efforts have met with some success, they all rely to some extent on guesswork as to the whims of the consumer public. If the marketing team or outsourced firm is in some way biased, or not perfectly knowledgeable about the target audience, as is common and practically unavoidable, then the marketing effort may fail or produce less-than-desired results.

### SUMMARY

Embodiments of the inventive method and software (collectively “the system”) allow direct consumer or public input for projects. The projects may be, e.g., collaborative design efforts, marketing efforts for a given product, and so on. For example, video game developers may employ the system to allow users to create, collaborate on, and vote on new maps, creatures, and other content for their games.

In particular, the system provides a software and service platform that may be implemented either as an Internet-based social collaboration service or a stand-alone software platform. The system provides a social Internet community framework that allows users to create short-cycle projects or contests that present a request, scenario or problem and asks the user community to collaborate on ideas and solutions that solve or fit the request. Anyone in the user community, or outside the user community, can start new projects and participate in existing projects by adding and collaborating on ideas. Through a selection process, e.g., community voting, a prevailing or winning idea is selected and all contributors to the prevailing idea are rewarded. Alternatively, all participants in the project may receive some reward. As may be apparent, variations in the reward scheme may be devised and still fall within the scope of the invention.

The project owner may automatically receive all community-generated content related to the project at the end of the project life cycle. In another implementation, the project owner may only receive content related to the prevailing idea. To accommodate requirements of copyright, idea content may be submitted under a Creative Commons License which provides an open environment that fosters collaboration while protecting the original owner from competing commercial use of the resulting ideas. Any number of different types of Creative Commons Licenses may be employed, according to the needs of the parties. Other types of such licenses may also be used. The project owner may also provide their own addendum to a standard site-wide user license, which the user must then accept before being allowed to participate in that project.

The user community as a whole is rewarded with social connections, peer satisfaction and individual contributors are rewarded with, e.g., “redemption points” based on their contribution to peer-chosen solutions and designs to the client project. The system includes a point redemption component that allows users to redeem earned redemption points for various sponsored prizes, gift cards and merchandise, e.g., t-shirts, hats, etc. Contributors may also be rewarded with direct cash payouts. In some cases, various cash or prize options may be made available only to premium members who pay a monthly subscription fee.

The software framework may use, in a special way, concepts of game theory. For example, in a simple example, the first contributor of a prevailing idea may receive 50% of the available redemption points or cash and additional contributors may split the remainder based on the number of contributions made and whether the contribution appears in the final content. Other schemes, including more complex schemes, may also be employed to calculate the participation level of each collaborative effort for every idea submitted for a project. Calculations may be used in which a determination is made of the level of collaborative “spirit” an idea owner has. For example, an idea owner that tends to disapprove other user's ideas may receive fewer points than an idea owner who encourages user collaborative efforts, such as via accepting user changes and comments. The software may assign weighted values for each participant using these calculations and may use these values to distribute both redemption points and cash payouts for winning ideas, designs and solutions.

In one aspect, the invention is directed towards a method of collaborating on a project, including steps of: accepting a project, the accepting including accepting starting content and one or more parameters about the project; accepting contributions for the project, each contribution associated with an idea for the project; accepting votes from respective users, the votes cast for one or more ideas pertaining to a project; determining a prevailing idea, the prevailing idea defining a set of final content; and delivering the final content to a project owner.

Implementations of the invention may include one or more of the following. The determining step may be based on the result of the step of accepting votes. The method may further comprise compensating users who contributed contributions to the prevailing idea, and the compensation may be determined using game theory, and/or may be based on the amount or quality of user participation in the prevailing idea. The compensation may be redemption points or cash payouts, and these may also be based on whether the user is a regular user (free) or a premium member (where a charge is involved). At least one of the one or more parameters may be selected from the group consisting of: time duration during which contributions will be accepted for a project, number of redemption points available for dispensation during or after a project, acceptable formats for receipt of content and idea. Contributions may be accepted from only registered users or only from users associated with the project. The method may further comprise providing an application wherein the project owner may sell or license the final content to a subsequent purchaser. The method may further comprise prohibiting users from contributing ideas or contributions if the users do not execute a license agreement. The registered users or users associated with the project may define a portion or all of a social network.

In another aspect, the invention is directed to a computer-readable medium containing instructions for causing a computer to implement the method above.

In a further aspect, the invention is directed to an application including: a project acceptance module, the module including a form to accept a set of starting content and one or more parameters about the project; a contribution acceptance module, the module including a form to accept contributions associated with an idea for the project; a prevailing idea determination module, the module including an algorithm to determine a prevailing idea from a set of contributed ideas; and a delivery module, the module including a delivery mechanism to deliver the final content to a project owner.

Implementations of the invention may include one or more of the following. The application may be a web application or a network application. The application may further comprise a sale and licensing module, the module including a form and application to conduct and/or transact the sale of the final content to a subsequent purchaser. The application may further include a social networking module, the module configured to: register users who wish to submit contributions or vote on projects; and allow users to communicate between each other.

In yet another aspect, the invention is directed to a social network operable on one or more computing systems, including: at least two systems operable by users connected to a network; a project acceptance module, the module including a form fillable by one of the at least two users to accept a set of starting content and one or more parameters about the project; a contribution acceptance module, the module including a form fillable by any of the at least two users, or a subset of the same, to accept contributions associated with an idea for the project; and a prevailing idea determination module, the module including an algorithm to determine a prevailing idea from a set of contributed ideas.

Implementations of the invention may include one or more of the following. The network may be the internet. The network may further comprise a compensation module, for compensating at least the users who contributed to the prevailing idea.

Advantages of the invention may include one or more of the following. The system may bring both innovation and community brand awareness together for any industry and market. The system gives project owners a useful platform for generating creative work and increasing innovation and increases brand awareness for the subject matter of the project.

The system may provide an active Internet community and social network built from users with various talent and skills in multiple areas that will produce new ideas and solutions in an open collaborative system. At the same time, advertisers and brand managers can use this open system to reach consumers and provide a tangible vehicle for brand awareness by engaging the user community to participate in a new marketing campaign or a new design direction. The system can deliver these new directions in innovation for project owners (which act as clients) by engaging multiple individuals of the community to work together and leveraging their collective experience, knowledge and talent to produce design, direction, art, ideas and creative solutions to achieve a common goal. In many cases, this common goal is a project or task presented by a client, but could be anything that needs a solution or design.

Besides the additional community-generated content and design for the project, clients gain brand exposure by involvement within and around the community. Not just exposure as with a simple ad banner, but actual design contributions as well—working with a brand to develop new designs and ideas.

By involving the community to solve design problems and invent new advertising campaigns, clients imprint their brand onto the community as a side effect. Simply seeing an advertisement has much less impact and memory retention than participating in making a campaign or solving a problem for that brand.

The software and service framework may be employed by external companies as a strategy for generating revenue and growing the user community. These companies may use the system as an in-house, open research and development product innovation platform and may choose to limit community participation to employees only—or expand to involve key customers as well.

The system may allow ‘private’ projects using a ‘groups’ feature. That is, a project owner can start a new project and restrict its visibility and participation to predefined and/or private groups. These groups may be collections of users, which may or may not typically collaborate, but which can view restricted projects or ideas. Idea owners may also designate ideas, even for public projects, as “group only” and can therefore only be the subject of collaboration by other group members. In various implementations, the idea can be voted on by the group or by a different group, but the active collaborative area of the idea is restricted. This may be particularly important for some companies that desire to control projects having certain marketing or branding efforts by limiting access to smaller, more contained groups.

Certain system implementations may also enjoy one or more of the following benefits. Multiple incentives may be provided for participation, such as merchandise, cash, social benefits, prizes, etc. Multiple vertical markets may be targeted. Different revenue models are made possible, such as online advertising revenue, software licensing, and user memberships. The system may enjoy complete automation, from account signup to payout of prizes. The system may offer multiple incentives. In particular, e.g., project owners receive an increase in innovation, ideas and assets, brand exposure to community, etc.; the community receives cash and prizes, social networking, and a public showcase of skills, e.g., for job hunting. The system can be applicable in many sectors: advertising, merchandising, public relations, marketing, game design, engineering and industrial design, medical design, software development, fashion, architecture, science and technology, and internal company uses—indeed any sector could benefit that employs a collaborative community design system to solve problems, generate new designs and increase innovation. The system also allows multiple access levels, such as public, groups, friends, and project types.

### BRIEF DESCRIPTION OF THE DRAWINGS

FIG. 1 shows a flowchart of a basic embodiment of the invention.

FIG. 2 shows a flowchart detailing a step of creating a new project.

FIG. 3 shows a flowchart detailing a step of starting a collaboration and collecting user content.

FIG. 4 shows a flowchart detailing a step of encouraging collaboration.

FIG. 5 shows a flowchart detailing a step of maintaining and promoting a project.

FIG. 6 shows a flowchart detailing a step of deciding on the final content and calculating user contributions.

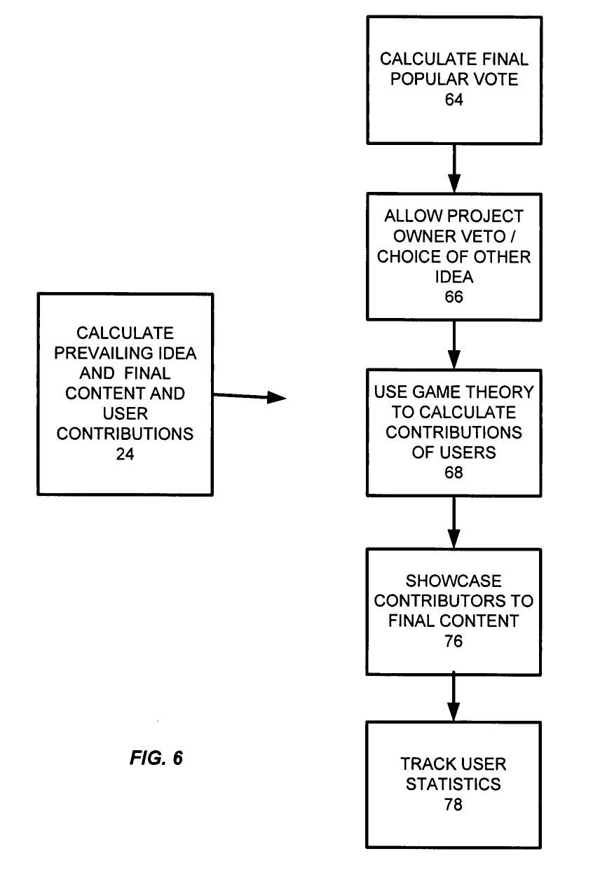

FIG. 7 shows a flowchart detailing a step of providing redemption points to users.

### DESCRIPTION

The following terms are used in this description, and are defined here.

A “project” is a short- or long-term proposal about which or for which an individual, company, or other entity desires contributed content. The proposal may be a contest, or may present a request, scenario, design request, or problem. The user community is asked to collaborate on ideas or solutions. Anyone in the user community, or in many cases outside the user community, can start new projects and participate in existing projects by adding and collaborating on ideas.

A “project owner” is generally the owner of any final content, and is usually the person or entity who initiates a project. Others, often under the control of the project owner, may also initiate the project.

“Starting content” constitutes all file, document, program, tool, link, and image assets provided to initiate a project, often provided by the project owner or one under their control.

“Final content” constitutes the sum of the file, document, program, tool, link and image assets from the selected idea at the conclusion or after the conclusion of the project life cycle. “Final content” is associated with the idea that is selected as the “chosen” idea or the “winning” idea, which are broadly termed herein the “prevailing idea”.

“Total content” constitutes the sum of the starting content, final content, and any other content contributed by the user community to the project or project owner. Total content may include content that does not appear in the final content, e.g., “losing content” or content that was transitional in the sense that it was a preliminary step in the development of the final content.

The “user community” is a network of users who can contribute to a project. The user community may be open to anyone who can access the project using the internet, or may be limited by the project owner or another to only a certain group of users. In any case, a “user” is any member of the user community. The user community may be of all a single type, or may consist of different types of users. For example, the user community may consist of regular or free users and premium members. Free users may establish their accounts through a standard registration process and may further thereby setup their public profile. Premium members may use the same registration process and may also be charged a small monthly fee (i.e., 2-5 dollars). Premium members can gain additional high-profile project access and may be rendered eligible to receive direct cash payouts. Cash payouts are available during the redemption of redemption points or during special projects that choose to payout in cash prizes instead of redemption points. A free user account may be, e.g., upgraded to a premium account at any time.

“User-contributed content” or “UCC” is content contributed by a user to a project. This may be original content or non-original content, and may be generated in any fashion. UCC is generally organized into different “ideas”, and each idea has one or more contributions to the same. Once an idea has been initiated, either the contributing user, or the entire user community, or a subset of the community, may modify or add to the idea, depending upon the particular rules chosen for the project.

“Redemption points” are points available for redemption in exchange for prizes, gifts, gift cards, cash or any other type of remuneration, generally in exchange for user-contributed content. Where the term “redemption points” is used in this description, the same may be replaced with cash or money or other types of liquid remuneration.

“Content” refers to files, ideas, documents, images, or any other type of asset contributed to a project. Generally, content will be copyrightable, but the same need not necessarily be.

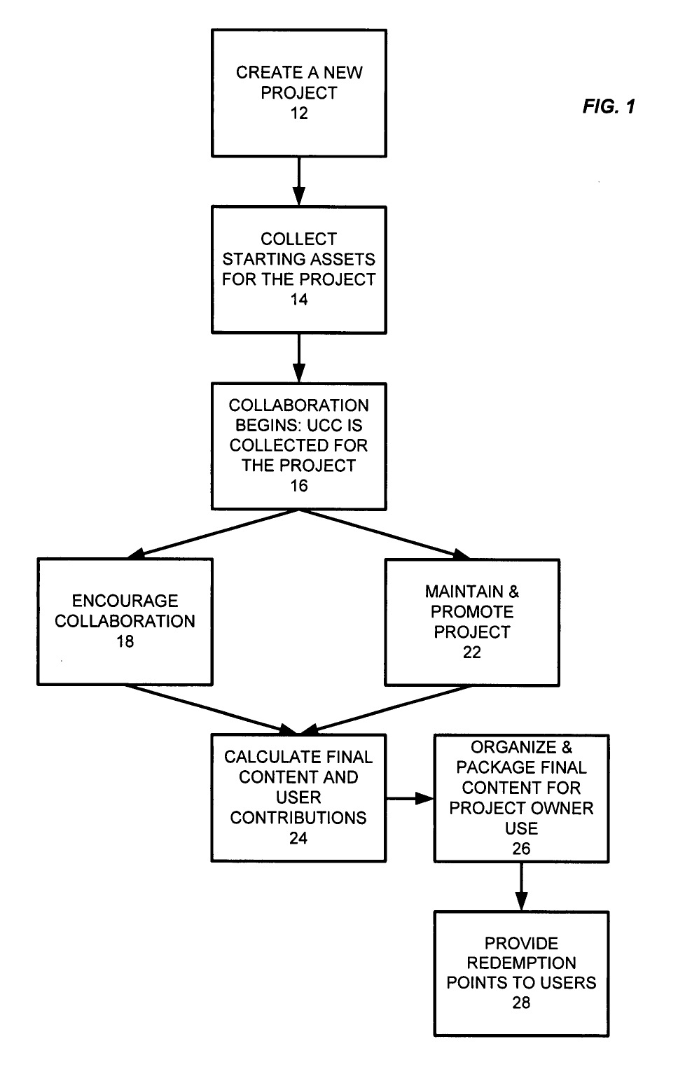

Referring to FIG. 1, the basic software framework is shown (additional details about each step are provided below). The system uses a particular software framework as the underlying technology which automates and facilitates the interaction between a project owner and the user community from beginning to end.

The first step is the creation of a new project (step 12). The new project may be initiated by a project owner or by one acting on behalf of the same. The next step is to collect the starting assets for the new project (step 14). The starting assets are usually provided by the project owner, and include all file, document, and image assets for the project. The starting assets may give users an indication of what sort of contributions will be desired.

Following the collection of the starting assets, the project collaboration can begin (step 16). At this point, users in the user community can contribute content to the project, typically in the form of ideas, and may receive credit such as redemption points for doing so (though in many cases final award of redemption points may only be made to those who contribute to the selected prevailing idea, i.e., those who contribute to the final content).

Collaboration can be encouraged in various ways (step 18), such as via ranking users in the user community, and the project can be maintained and promoted (step 22). Users may also approve and disapprove of other user's collaborations in an open on-going approval process. This may act as a method to encourage the community to self-police the activity. Responsible users may, e.g., disapprove en mass a misbehaving or mischievous user who submits inappropriate or offensive content.

Once the period for collaboration is ended, the period definable in various ways, a calculation may occur of the prevailing idea and its associated final content. In some embodiments, the prevailing idea may be considered “winning” as determined by a vote. Other criteria may also be employed. In any case, the prevailing idea is selected (step 24).

Then the project and final content are organized and packaged for the project owner (step 26). The final content is then generally delivered to the same. The final contents or total contents may be sold or licensed to a purchaser, if desired, within the framework of the system. Redemption points are provided or distributed according to an appropriate scheme.

These steps are now described in more detail.

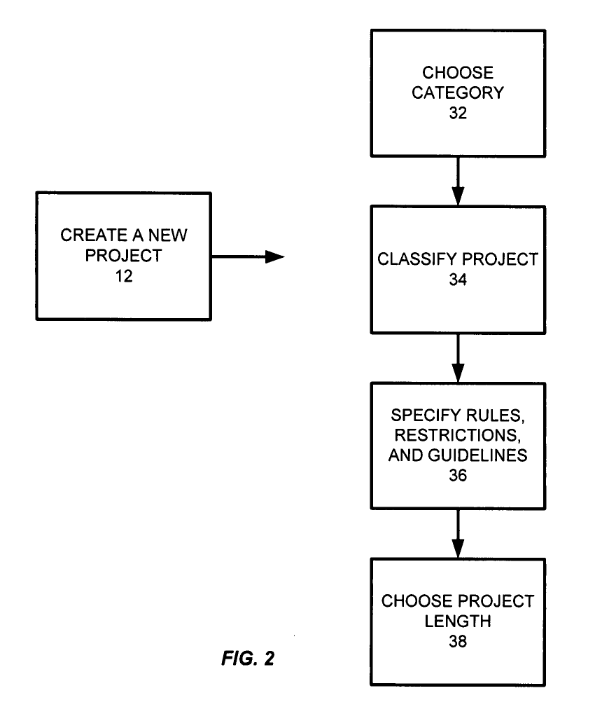

Referring to FIG. 2, with regard to creation of a new project (step 12), users can start projects under a variety of different categories or sectors to leverage community knowledge and experience in order to develop ideas, designs, assets and solutions. Project owners may classify (step 34) their projects in various ways. One way is by choosing a category (step 32) or a creative medium type, e.g., outdoor/billboard, online ads, print ads, TV, radio, etc. Such a classification allows users to find projects in which they have skill and/or may be interested in participating.

Project owners may also specify certain rules and guidelines for the project (step 36). This is essentially a briefing on the project and/or the brand (or their client) for the user community. The system offers different project types from which the project owner may choose. The first is full, open collaborative projects where the users see all ideas and can openly contribute to any of them, creating an organic brainstorming environment. Another is a limited collaborative project where the users can see all ideas but can only add contributions to their own ideas The original submitter of an idea can revise their idea by publishing a new “version” of the idea. In this case, even though other users may not add on to the idea, the original owner is still allowed to make revisions. Another project type is a blind idea collection where projects collect ideas but the users cannot see any other idea other than their own and can make contributions only to their own idea.

In addition to project type, project owners may also choose certain restrictions on who can participate in the project. In an open and public project, everyone can see and participate in the project. Another restriction may be that the project is private to a certain group of users. That is, the project is hidden unless the user is a group member. This type of project is particularly useful for internal projects. Another restriction may be that the project is private to premium membership users. That is, the project is visible to everyone, but only users with premium subscriptions can participate. Another typical restriction or rule would be on the project length (step 38).

As may be apparent, various combinations or alterations of these restrictions may also be employed, and are within the scope of the invention.

Regarding the next step, project owners start a new project and upload any needed assets, such as files, documents or applications needed, by filling out a quick form of information and choosing the project length, of which examples may be 1 week, 2 weeks, 1 month, etc.

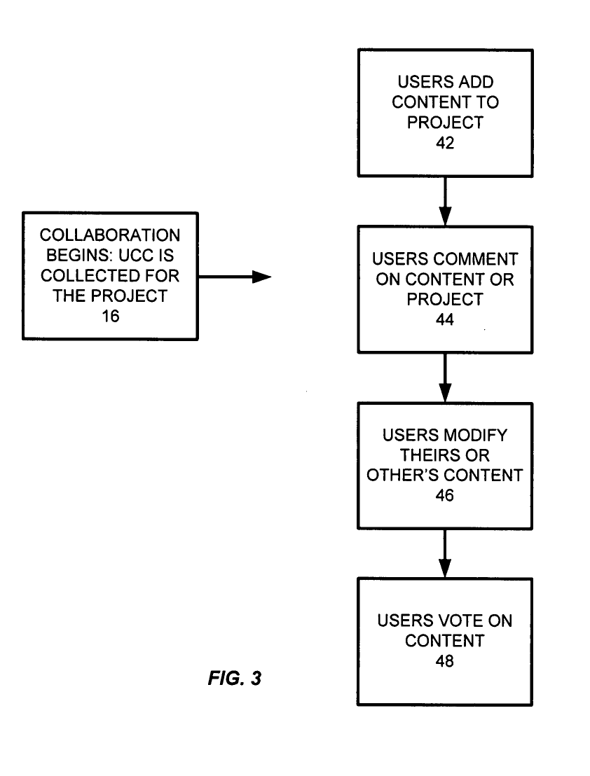

Referring to FIG. 3, and regarding step 16, once a project is active—and based on applicable visibility as is set by restrictions on the project set in prior steps, the user community is able to join the project and collaborate to submit ideas that solve the project request or directive. Contributions are grouped into ideas, i.e., each idea has one or more contributions associated with it, where the contributions for any given idea may be from one or more users, depending on the rules of the project. Users may add their own ideas (step 42) and comments (step 44) and may vote (step 48) and improve upon their own or other participant entries (step 46).

Assets and creative ideas are generated by the user community in a collaborative environment, which may have certain aspects of a contest. Entries may be on-going and open for review by the community as well as being available for revisions throughout the project lifecycle.

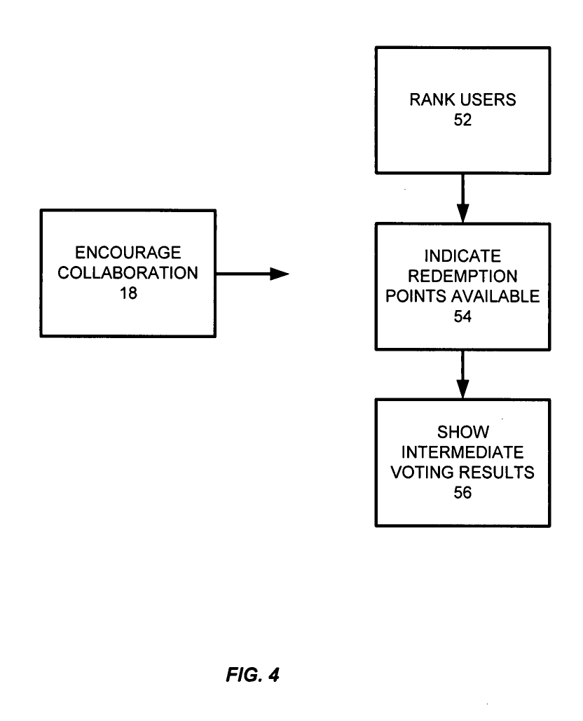

Referring to FIG. 4, and describing in more detail the encouraging collaboration step, during the project life cycle, the entire user community is encouraged to vote on the best or most appropriate idea for a given project. Any member of the system can vote on any visible project. In some implementations users need not have contributed to the project in order to vote. Users can vote on multiple ideas for the same project. The voting system may be a modified approval voting system, where multiple choices can be made for the same contest. A user can cast a single vote for any idea at any time; however, they may also retract their vote as well at any time.

Users can be ranked (step 52) on their number of votes in different contests, their success on casting votes for winning projects, or on any other criteria. Redemption points may be indicated (step 54) as an enticement to vote. Intermediate voting results can also be shown (step 56), increasing excitement in the competition. Such visibility-enhancing features generally increase a user's willingness to vote, and create a more vibrant, active, productive, and useful social network.

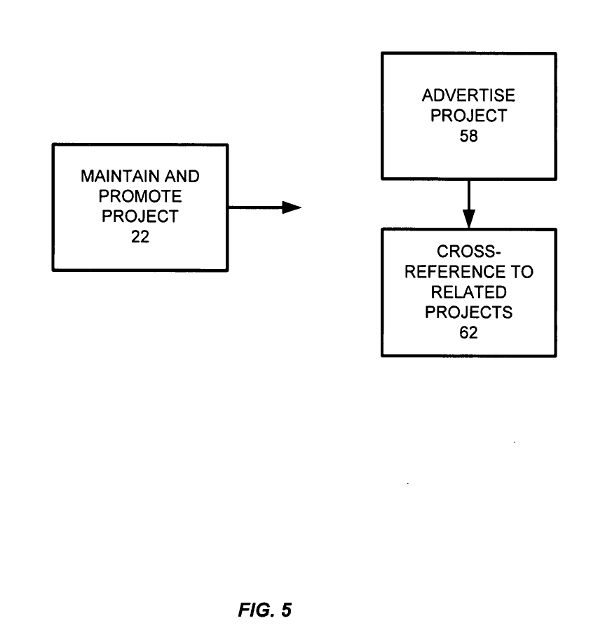

Referring to FIG. 5, and describing in more detail the maintaining and promoting project step 22, the project may be advertised on various websites (step 58), and cross-reference may be made on the project home page to other related projects to which the current set of participants, or viewers of the page, may be likewise interested (step 62).

Other ways to promote the concepts of embodiments of the invention include a list of the newest projects, the newest contributions (also known as ideas), and/or the top or newest contributors. In this way, recognition is given for involvement, increasing interest in the latter. Other promotions include a list of the most popular projects or contributions and/or the newest projects or contributions.

Another way to increase excitement in the project is to provide a graph or other indicator of project activity. One such graph has day or time as the x-axis and number of contributions on the y-axis, with different projects having different symbols. One of ordinary skill in the art will understand that variations of this scheme are also within the scope of the invention. For example, the y-axis may indicate voting on projects instead. The graphs may change as the project progresses, and they may be added or deleted at anytime. Other methods of visually communicating the status of activities within the system are also possible.

Regarding step 24, when the project closes, there may be generally calculated or determined a single popular winner (step 64); however, the top voted ideas for that project may be available to the project owner for, e.g., veto (step 66) for, e.g., 36 hours. During this period, the project owner may choose to overrule the popular vote and choose a different winning idea. If there is no veto or the time period is elapsed, the most popular idea may be chosen as the prevailing idea. In any case, once a prevailing or winning idea is settled on, the contributions associated with it are deemed the final content.

The system may calculate weighted values for all users who collaborated in the winning idea and award redemption points or payout cash appropriate to the calculated value of participation. Such calculations may employ aspects of game theory (step 68). Other techniques may also be employed, and the same generally may be based on the quality or quantity of a user's contribution, or both.

The winning idea, idea owner and all user collaborators may be showcased in a “winner's circle” area and given various recognition, e.g., fan fare (step 76). A list and short description or thumbnail of the latest winning projects may be provided.

The user community profiles may track user statistics and rankings (step 78). The user profiles may be updated automatically and reflect rankings, redemption points and current projects joined, ideas submitted, subscribed groups, listed friends, as well as a portfolio of their latest contributions to projects and ideas.

In addition, a non-anonymous and persistent community helps keep shilling, cheating and abusive behavior reduced and helps increase “stickiness” by creating and nurturing a persona within the community.

Regarding step 26, the system may automatically archive and make available for delivery to or retrieval by the project owner all generated designs, files and user contributions as well as activity reports to use or modify as they wish. In general, all generated content for a project is given to the project owner, not just the final content, although variations of this are manifold.

At the end of a project cycle, all related assets, ideas and solutions are packaged automatically and made available to the project owner along with reports of usage, participation, viewing and voting metrics.

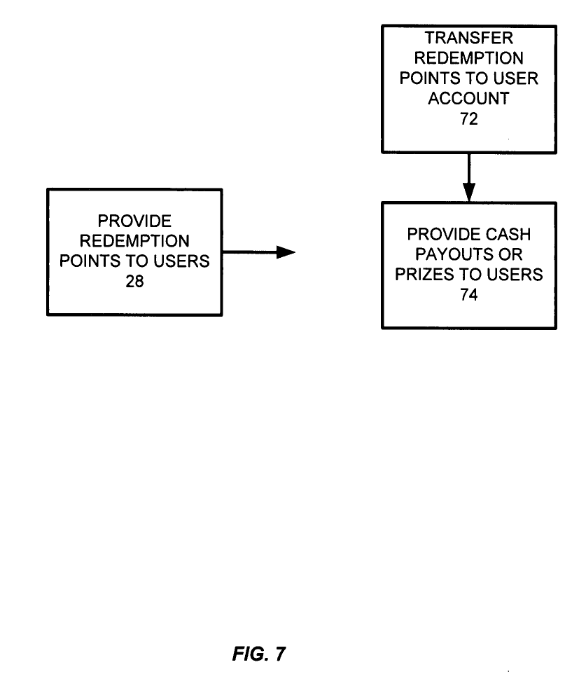

Regarding step 28, as shown in FIG. 7, the step of providing redemption points to users may include steps of transferring redemption points to a user account (step 72), and/or providing cash payouts to users (step 74).

Project owners receive all rights and commercial usage of idea assets after the closing of a project through use of known Creative Commons Licenses. Some special projects, such as those with high profiles or important licensees, may require an additional user acceptance when participating in a project if content needs additional legal protection.

Registered users, as a part of the initial registration process, may accept a legal agreement outlining the restrictions and rights regarding their submissions as well as the project owner assets, e.g., images, text, messages, etc., to be uploaded and used in the project and/or ideas. Registered users, or in some embodiments any viewer of the site, may browse or search for projects in which they may have an interest. For example, a search may be conducted by tag or keyword, by category, or by type of media, e.g., billboard, banner ad, etc.

### EXAMPLE

A coffee bar may start a one-month project to collect ideas on a new in-store marketing campaign. Users collaborate and generate hundreds of new and innovative ideas for the new campaign. The coffee bar receives dual benefits: a substantial amount of ideas to use or leverage in any way they see fit, and a large user community that was exposed to effective brand identification.

While the system has been described with respect to certain embodiments, it is clear that the scope of the invention is broader than the described embodiments. For example, use of the system in internal environments and for more private projects may be accomplished with a Groups functionality. This Groups functionality allows users to form groups of other users by invitation. Projects can optionally be restricted as hidden from everyone except group members. Public projects can have ideas that are group-only as well. This allows a group of users to work together privately on a public project without outside collaboration. The Groups feature is useful in increasing the scope of the system and service.

In another implementation, the advertising and public relation sectors could make use of even a small community to develop ideas and solutions for print ads, billboards, design ideas, campaign themes, television and radio spots, etc. Any area of advertising creativity is open to the collaborative environment that the system supports. Thus, this type of use may be branched into numerous other sectors.

Still many other vertical markets and business sectors exist as possible employers of embodiments of the invention. For example, one implementation may be specifically related to venture capital firms. In this implementation, the software and method may be designed to generate or uncover new innovative business models and directions for investment opportunity.

Moreover, ownership of the final content need not be limited to the project owner. Rather, the owner of the final content may immediately or later sell or trade the collaboratively created content to other users. In this embodiment, the original creators may share a portion or all of the earnings from such a sale. The sharing may be based on, e.g., their participation level or on some other factor or factors. The sharing may be the same or different as the original redemption point or cash payout. The embodiments of the invention may in particular provide within the user interface a digital asset sale of the final content to another entity. Of course, intermediate content, i.e., all UCC not embodied in the final content, may also be sold, subject to the terms of the chosen Creative Commons License. It will be understood that a complete sale is not necessary—the final content may merely be licensed to a new owner if preferred by the user.

Additionally, it was noted above that the user community may consist of free users and premium members. The steps described above may branch to different functionality depending on whether the user is a regular (free) user or a premium member. While the details differ by implementation, steps particularly susceptible to branching may include steps 12, 24, 26, 28, 42, 46, 48, 66, 72, and 74.

Accordingly, the scope of the invention is to be limited only by the claims appended hereto.

1. A method of collaborating on a project, comprising:
a. accepting a project, the accepting including accepting starting content and one or more parameters about the project;
b. accepting contributions for the project, each contribution associated with an idea for the project;
c. accepting votes from respective users, the votes cast for one or more ideas pertaining to a project;
d. determining a prevailing idea, the prevailing idea defining a set of final content;
e. delivering the final content to a project owner.

2. The method of claim 1, wherein the determining step is based on the result of the step of accepting votes.

3. The method of claim 1, further comprising compensating users who contributed contributions to the prevailing idea.

4. The method of claim 3, wherein the compensation is determined using game theory.

5. The method of claim 3, wherein the compensation is based on the amount or quality of user participation in the prevailing idea.

6. The method of claim 3, wherein the compensation is redemption points or cash payouts.

7. The method of claim 1, wherein at least one of the one or more parameters is selected from the group consisting of: time duration during which contributions will be accepted for a project, number of redemption points available for dispensation during or after a project, acceptable formats for receipt of content and idea.

8. The method of claim 1, wherein the contributions are accepted from only registered users or only from users associated with the project.

9. The method of claim 1, further comprising providing an application wherein the project owner may sell or license the final content to a subsequent purchaser.

10. The method of claim 1, further comprising prohibiting users from contributing ideas or contributions if the users do not execute a license agreement.

11. The method of claim 8, wherein the registered users or users associated with the project define a portion or all of a social network.

12. A computer-readable medium containing instructions for causing a computer to implement the method of claim 1.

13. An application, the application comprising:
a. a project acceptance module, the module including a form to accept a set of starting content and one or more parameters about the project;
b. a contribution acceptance module, the module including a form to accept contributions associated with an idea for the project;
c. a prevailing idea determination module, the module including an algorithm to determine a prevailing idea from a set of contributed ideas;
d. a delivery module, the module including a delivery mechanism to deliver the final content to a project owner.

14. The application of claim 13, wherein the application is a web application.

15. The application of claim 13, wherein the application is a network application.

16. The application of claim 13, further comprising a sale and licensing module, the module including a form and application to conduct and/or transact the sale of the final content to a subsequent purchaser.

17. The application of claim 13, further comprising a social networking module, the module configured to:
a. register users who wish to submit contributions or vote on projects; and
b. allow users to communicate between each other.

18. A social network operable on one or more computing systems, comprising:
a. at least two systems operable by users connected to a network;
b. a project acceptance module, the module including a form fillable by one of the at least two users to accept a set of starting content and one or more parameters about the project;
c. a contribution acceptance module, the module including a form fillable by any of the at least two users, or a subset of the same, to accept contributions associated with an idea for the project; and
d. a prevailing idea determination module, the module including an algorithm to determine a prevailing idea from a set of contributed ideas.

19. The network of claim 18, wherein the network is the internet.

20. The network of claim 18, further comprising a compensation module, for compensating at least the users who contributed to the prevailing idea.
